(19) United States
(12) Patent Application Publication
(10) Pub. No.: US 2006/0195434 A1
(43) Pub. Date: Aug. 31, 2006

(54) Multiple Invocation Style Integration Framework

(75) Inventor: John Mourra, Markham, Ontario (CA)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 10/906,592

(22) Filed: Feb. 25, 2005

(51) Int. Cl. G06F 17/30

(52) U.S. Cl. 707/4

(57) ABSTRACT

A multiple invocation style framework. A system for accommodating multi-style application component invocation can include a command layer configured for association with one or more commands. The system also can include an invocation adapter layer having one or more different invocation adapters. Each of the different invocation adapters can include programming to morph to a specified registered command satisfying a specific type of invocation style. In this regard, the specific type of invocation style can be one of a direct invocation, a batch invocation, a builder invocation, and a user interface invocation. In any case, when invoked, each adapter further can invoke at least one of the commands. Finally, the system can include a command factory providing access for invoking registered ones of the commands on behalf of accessing ones of the different invocation adapters.

### BACKGROUND OF THE INVENTION

The present invention relates to the field of software development and more particularly to command invocation in a software application.

### DESCRIPTION OF THE RELATED ART

The development of large-scale software solutions typically involves the work of a large number of individuals—often in the range of hundreds to thousands of people who belong to various organizationally and geographically separate teams. Coordinating a software development effort at this level no doubt can be wrought with several challenges. One well known challenge—the challenge of integrating distinctly created programmatic components to create a seamless, unitary software product—stands as a core barrier to the success of large-scale product development.

Generally, individual programmatic components can be viewed as a combination of three central elements: data, logic and an invocation interface to the logic. In many cases, the invocation interface to the logic can be provided through a direct access interface, through which logic can be accessed directly via an application component command. In other cases, the logic can be invoked via an interface resource such as a graphical or audible user interface. In some circumstances, however, other modes of accessing the data and logic can be provided, such as an event-driven incremental builder invocation interface or through a batch-mode interface. In particular, often end users prefer to utilize a software application in a mass production environment rather than a single-user environment. Accordingly, at the outset, a component designer may be required to select an appropriate invocation interface to the exclusion of other types of invocation interfaces.

With a view to different interface configurations, various strategies have been employed to tackle the issue of application integration. Yet, as noted, at the heart of most strategies is the inherent requirement that the developer of the application component must pre-determine the mechanism by which the particular component will be invoked. In more concrete terms, the developer must decide initially whether or not to provide a component that will support a user interface based invocation, an incremental builder based invocation, an event-triggered invocation, an independent batch task invocation, or simply a direct invocation.

The pre-determination of a component invocation interface can dictate how the developer implements the application component. Specifically, the pre-determination of a component invocation interface can dictate to the developer which interfaces to extend, and which extension mechanism to use, to name a few. Additionally, the skilled artisan will recognize the requirement that a component developer enjoys intimate knowledge of the requirements of a particular framework subject to extension. In this regard, the particular framework can range from a user interface wizard framework, a project builder framework, or a batch execution type framework. Accordingly, what is needed is a general framework able to support multiple styles of component invocation.

### SUMMARY OF THE INVENTION

The present invention addresses the deficiencies of the art in respect to application component invocation and provides a novel and non-obvious method, system and apparatus for a multi-style integration framework configured to handle multiple style application component invocation. A system for accommodating multi-style application component invocation can include a command layer configured for association with one or more commands. For example, the command layer can accept registrations from the different commands. The system also can include an invocation adapter layer configured for association with one or more different invocation adapters, each adapter including programming to invoke at least one of the commands according to a specific type of invocation style. In this regard, the specific type of invocation style can include an invocation style selected from the group consisting of direct invocation, batch invocation, builder invocation, and user interface invocation.

Finally, the system can include a command factory providing access for invoking registered ones of the commands on behalf of accessing ones of the different invocation adapters. Notably, a configuration layer can be configured for association with one or more configurations of the commands in the command layer. In this regard, the configurations can include an aggregation of commands which can be invoked in a single invocation of the configuration. Accordingly, the configurations can be be invoked by the adapters in lieu of a direct invocation of any one of the registered commands in the command layer.

A method for accommodating multi-style application component invocation can include registering one or more commands for invocation within a multi-style application component invocation framework. The method also can include configuring at least one invocation adapter to morph to a specified one of the registered commands. Finally, the method can include invoking the specified one of the registered commands through the configured invocation adapter. Preferably, one or more configurations can be established. Each configuration can have an association with at least two of the registered commands. At least one invocation adapter can be additionally configured to morph to a specified one of the configurations. Moreover, the specified one of the configurations can be additionally invoked through the configured invocation adapter.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of an application framework configured to accommodate multi-style application component invocation;

FIG. 2 is an object model of a configuration layer and a command layer in the framework of FIG. 1;

FIG. 3 is a flow chart illustrating a two-tier process for accommodating multi-style application component invocation;

FIG. 4 is a block diagram illustrating a generic batch invocation adapter configured for interoperation with the command layer of the framework of FIG. 1; and,

FIG. 5 is a block diagram illustrating a generic builder invocation adapter configured for interoperation with the command layer of the framework of FIG. 1.

### DETAILED DESCRIPTION OF THE PREFERRED EMBODIMENTS

The present invention is a method, system and apparatus for a multi-style application component integration framework. In accordance with the present invention, a multi-style application component integration framework can provide a simple and generic command interface to application components which can be invoked by way of multiple different invocation methods, including direct invocation, batch invocation, builder invocation, and user interface invocation, to name a few. The framework can include multiple invocation adapters, each adapter accommodating a different invocation method. The invocation adapters, in turn, can be configured to activate underlying application component commands, including aggregations of several underlying application component commands. Consequently, an application component can accommodate multiple invocation methods without requiring specific logic to handle any one of the invocation methods.

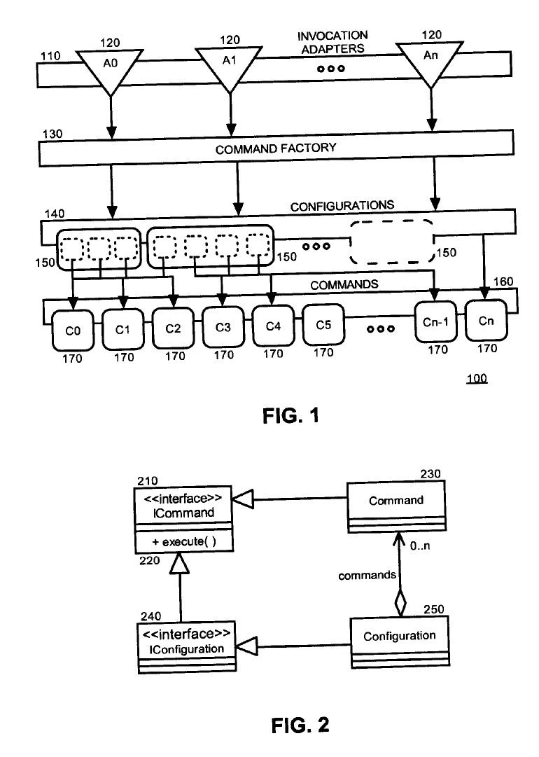

In more particular illustration of an embodiment of the present invention, FIG. 1 is a schematic illustration of an application framework 100 configured to accommodate multi-style application component invocation. The framework 100 can include an invocation adapter layer 110, a command factory 130, a configuration layer 140, and a command layer 160. The adapter layer 110 can be communicatively coupled to one or more invocation adapters 120. Each of the invocation adapters 120 can accommodate a specific invocation method, such as direct invocation, batch invocation, builder invocation, and user interface invocation, to name a few.

The adapters 120 through the invocation adapter layer 110 can be configured to communicate with the command factory 130 to access one or more underlying commands 170 registered for use in the command layer 160. Specifically, each of the commands 170 can be registered with a command registry (not shown) and each command can be assigned a unique identifier. Once registered, the adapters 120 can lookup and invoke the commands 170 via the command factory 130. Notably, sets of the commands 170 can be grouped together into a command aggregation 150 which aggregation can be registered with the command registry and accessed by the adapters 120 via the command factory 130.

FIG. 2 more specifically illustrates the grouping of commands into configurations in accordance with the present invention. In particular FIG. 2, is an object model of a configuration layer and a command layer in the framework of FIG. 1. As shown in FIG. 2, a concrete configuration object 250 can implement a configuration interface 240 which can extend a command interface 210. Similarly, a concrete command object 230 can implement the command interface 210. The command interface 210 can define an exposed method 220 for executing command logic. One or more instances of the command object 230 can be associated with the configuration object 250 such that the configuration object 250 can be an aggregation of commands. Also, the configuration object 250 can define an exposed method 220 for executing command logic.

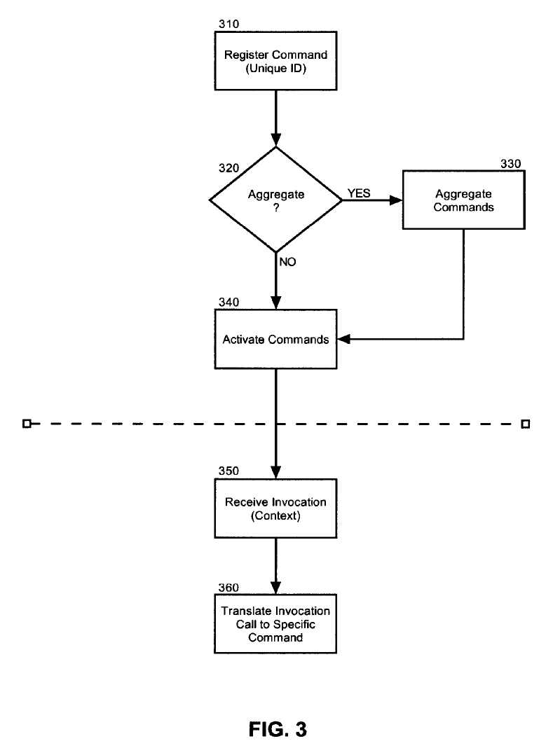

In operation, the framework of FIG. 1 can accommodate multiple invocation styles for registered commands. In illustration, FIG. 3 is a flow chart depicting a two-tier process for accommodating multi-style application component invocation. Beginning in block 310, one or more commands can be registered with a command registry. Additionally, in decision block 320, if selected ones of the registered commands are to be aggregated into a configuration, in block 330 selected ones of the registered commands can be aggregated into one or more configurations. Subsequently, in block 340, the commands and configurations can be activated to run as multiple types of components, morphing to fit into any enabled invocation style by way of the invocation adapters.

In this regard, when invoked, in block 350 the invocation can be received and processed along with a provided execution context. An execution context can be passed through the invocation adapters to the invoked commands or configurations as the case may be. To the extent that configurations are to receive the execution context, the configurations in turn can pass the execution context to aggregated ones of the commands. In either case, the execution contexts can encapsulate properties set by the invoking platform, such as user interface gathered user input. The execution contexts further can encapsulate logic permitting return communication with the invoking platform, such as error reporting or progress monitoring. In this way, the execution contexts facilitate the sharing of operational information for an invoked command across different commands.

Finally, in block 360, the received invocation can be translated to a specific underlying command or configuration as the case may be. In particular, to enable multi-style invocation, the invocation adapters can delegate invocation of the application component to integrated commands via an interface to the command factory. In essence, a particular invocation adapter can plug into an existing mechanism such as a builder framework in a development tool, a batch execution framework, or a user interface operation framework. Subsequently, the invocation adapter can translate calls made to the adapter to commands plugged into the multiple invocation style integration framework.

Importantly, it will be recognized by the skilled artisan that the design of a particular invocation adapter can be specific to that adapter and the design can depend in many cases upon the adapted platform. It is a particular advantage of the present invention that the framework can allow the independent implementation of adapters that suit the various styles of invocation and execution available. In any case, a default adapter can be provided along with the framework which can permit the manual triggering of the execution of any registered command or configuration. Specifically, the default adapter can trigger the execution of a registered command or configuration by specifying the unique identifier of the command or configuration, respectively, without regard to the source of the command or the location of the actual implementation of the command.

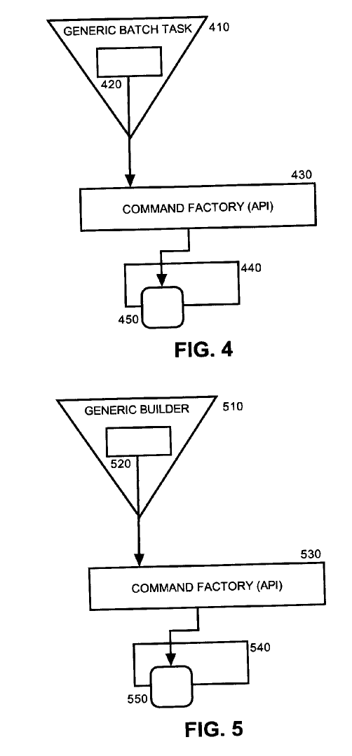

To that end, several generic adapters can be provided to support different types of invocation platforms without requiring specific invocation logic with the application component to support the different types of invocation platforms. FIG. 4 depicts one, exemplary adapter—a generic batch invocation adapter—configured for interoperation with the command layer of the framework of FIG. 1. The generic batch adapter 410 can include logic 420 permitting the execution of integrated commands, allowing users of the framework to gain access to all plugged-in functionality through a batch-mode environment without requiring the use of a graphical user interface.

In operation, adapter 410 can interface with the command factory 430 and corresponding application programming interface (API) to automatically access all available, registered commands 450 in the command layer 440. Once accessed, the commands 450 can be morphed into specific batch tasks based upon a specified unique identifier for a registered command or configuration. Accordingly, the design of the adapter 410 can include the mapping of the batch call to the command API. Elements of the batch call can identify the particular command (unique identifier) to invoke along with providing user input data (from a context) to be passed into the command.

As another example, FIG. 5 depicts a generic builder invocation adapter configured for interoperation with the command layer of the framework of FIG. 1. The generic builder adapter 510 can include logic 520 permitting the event-driven execution of integrated commands. In consequence, users of the framework can gain access to all plugged-in functionality through an event listener or builder mechanism rather compelling the users to utilize a graphical user interface.

In operation, adapter 510 can interface with the command factory 530 and corresponding application programming interface (API) to automatically access all available, registered commands 550 in the command layer 540. Once accessed, the commands 550 can be morphed into specific event-driven or builder type tasks based upon a specified unique identifier for a registered command or configuration. Accordingly, the design of the adapter 510 can include the mapping of the event-triggered or builder-based call to the command API. Elements of the event-triggered or builder-based call can identify the particular command (unique identifier) to invoke along with providing user input data (from a context) to be passed into the command in sequence upon receiving a resource change event.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

What is claimed is:

1. A system for accommodating multi-style application component invocation comprising:
a command layer configured for association with a plurality of commands;
an invocation adapter layer having a plurality of different invocation adapters, each of said different invocation adapters comprising programming to morph to a specified registered command satisfying a specific type of invocation style; and,
a command factory providing access for invoking registered commands on behalf of accessing ones of said different invocation adapters.

2. The system of claim 1, further comprising a configuration layer configured for association with a plurality configurations of said commands in said command layer.

3. The system of claim 1, wherein said specific type of invocation style comprises an invocation style selected from the group consisting of direct invocation, batch invocation, builder invocation, and user interface invocation.

4. A method for accommodating multi-style application component invocation comprising the steps of:
registering a plurality of commands for invocation within a multi-style application component invocation framework;
configuring at least one invocation adapter to morph to a specified one of said registered commands; and,
invoking said specified one of said registered commands through said configured invocation adapter.

5. The method of claim 4, further comprising the steps of:
establishing a plurality of configurations, each configuration having an association with at least two of said registered commands;
additionally configuring at least one invocation adapter to morph to a specified one of said configurations; and,
additionally invoking said specified one of said configurations through said configured invocation adapter.

6. The method of claim 4, wherein said invoking step comprises the steps of:
receiving a context for said specified one of said registered commands; and,
invoking said specified one of said registered commands utilizing parameters encapsulated by said received context.

7. The method of claim 5, wherein said additionally invoking step comprises the steps of:
receiving a context for said specified one of said configurations; and,
additionally invoking said specified one of said configurations utilizing parameters encapsulated by said received context.

8. The method of claim 4, wherein said configuring step comprises the step of configuring at least one invocation adapter to morph to a specified one of said registered commands corresponding to a unique identifier assigned to said specified one of said registered commands.

9. The method of claim 5, wherein said additionally configuring step comprises the step of additionally configuring at least one invocation adapter to morph to a specified one of said configurations corresponding to a unique identifier assigned to said specified one of said configurations.

10. The method of claim 4, wherein said configuring step comprises further configuring said at least one invocation adapter to invoke a specified one of said registered commands utilizing an invocation style selected from the group consisting of direct invocation, batch invocation, builder invocation, and user interface invocation.

11. The method of claim 5, wherein said additionally configuring step comprises further additionally configuring said at least one invocation adapter to invoke a specified one of said configurations utilizing an invocation style selected from the group consisting of direct invocation, batch invocation, builder invocation, and user interface invocation.

12. A machine readable storage having stored thereon a computer program for accommodating multi-style application component invocation, the computer program comprising a routine set of instructions which when executed by a machine causes the machine to perform the steps of:
registering a plurality of commands for invocation within a multi-style application component invocation framework;
configuring at least one invocation adapter to morph to a specified one of said registered commands; and,
invoking said specified one of said registered commands through said configured invocation adapter.

13. The machine readable storage of claim 12, further comprising an additional set of instructions for causing the machine to further perform the steps of:
establishing a plurality of configurations, each configuration having an association with at least two of said registered commands;
additionally configuring at least one invocation adapter to morph to a specified one of said configurations; and,
additionally invoking said specified one of said configurations through said configured invocation adapter.

14. The machine readable storage of claim 12, wherein said invoking step comprises the steps of:
receiving a context for said specified one of said registered commands; and,
invoking said specified one of said registered commands utilizing parameters encapsulated by said received context.

15. The machine readable storage of claim 13, wherein said additionally invoking step comprises the steps of:
receiving a context for said specified one of said configurations; and,
additionally invoking said specified one of said configurations utilizing parameters encapsulated by said received context.

16. The machine readable storage of claim 12, wherein said configuring step comprises the step of configuring at least one invocation adapter to morph to a specified one of said registered commands corresponding to a unique identifier assigned to said specified one of said registered commands.

17. The machine readable storage of claim 13, wherein said additionally configuring step comprises the step of additionally configuring at least one invocation adapter to morph to a specified one of said configurations corresponding to a unique identifier assigned to said specified one of said configurations.

18. The machine readable storage of claim 12, wherein said configuring step comprises further configuring said at least one invocation adapter to invoke a specified one of said registered commands utilizing an invocation style selected from the group consisting of direct invocation, batch invocation, builder invocation, and user interface invocation.

19. The machine readable storage of claim 13, wherein said additionally configuring step comprises further additionally configuring said at least one invocation adapter to invoke a specified one of said configurations utilizing an invocation style selected from the group consisting of direct invocation, batch invocation, builder invocation, and user interface invocation.
